(19) United States
(12) Patent Application Publication
(10) Pub. No.: US 2026/0127596 A1
(43) Pub. Date: May 7, 2026

(54) SYSTEMS AND METHODS FOR AN AI-DRIVEN BLOCKCHAIN PROTOCOL COORDINATING INCENTIVIZED, RISK-AWARE AUTONOMOUS OPERATIONAL AGENTS FOR DYNAMIC RISK/RETURN MANAGEMENT OF TOKENIZED ASSETS

(71) Applicant: RMINT Inc, CARY, NC (US)

(72) Inventor: Balaji Kannaiyan, CARY, NC (US)

(73) Assignee: RMINT Inc, CARY, NC (US)

(21) Appl. No.: 19/438,576

(22) Filed: Jan. 1, 2026

Related U.S. Application Data
(63) Continuation of application No. 19/201,998, filed on May 8, 2025, now Pat. No. 12,541,765.
Application No. 19/201,998 is a continuation-in-part of application No. 18/116,881, filed on Mar. 3, 2023.
(60) Provisional application No. 63/643,942, filed on May 8, 2024.
(60) Provisional application No. 63/648,669, filed on May 17, 2024.
(60) Provisional application No. 63/648,672, filed on May 17, 2024.
(60) Provisional application No. 63/648,673, filed on May 17, 2024.

(51) Int. Cl. G06Q 20/40; G06Q 20/38

(52) U.S. Cl. CPC G06Q 20/401; G06Q 20/389

(57) ABSTRACT

A computer-implemented method is provided for autonomously managing tokenized assets associated with an operational venture using a blockchain protocol. The method includes deploying an agent coordination contract on a blockchain network, the contract storing on-chain incentive rules and maintaining lifecycle status and performance metrics for multiple autonomous operational agents. At least one autonomous agent is assigned to the operational venture through the contract. The agent coordination contract receives a performance report from the assigned agent, the report including operational data generated from an executed action. The contract autonomously evaluates the performance report against the on-chain incentive rules to determine a performance outcome. Based on the determined outcome, the agent coordination contract and/or an associated settlement contract autonomously updates one or more of the agent's on-chain lifecycle status, the agent's on-chain performance metrics, and a state of the tokenized assets representing the operational venture.

### REFERENCE TO RELATED APPLICATIONS

This application is a continuation of U.S. patent application Ser. No. 19/201,998, titled “SYSTEMS AND METHODS FOR AN AI-DRIVEN BLOCKCHAIN PROTOCOL COORDINATING INCENTIVIZED, RISK-AWARE AUTONOMOUS OPERATIONAL AGENTS FOR DYNAMIC RISK/RETURN MANAGEMENT OF TOKENIZED ASSETS”, filed May 8, 2025, which in turn is a continuation in part of U.S. patent application Ser. No. 18/116,881, titled “SYSTEMS AND METHODS OF PERSONALIZING SERVICES ASSOCIATED WITH RESTAURANTS FOR PROVIDING A MARKETPLACE FOR FACILITATING TRANSACTIONS”, filed Mar. 3, 2023, each of which is incorporated by reference herein in its entirety.

### FIELD OF THE INVENTION

Embodiments of the present invention relate generally to the field of financial technology, blockchain applications, artificial intelligence (AI) in asset management, and digital asset lifecycle management. More particularly, embodiments relate to AI-driven blockchain protocols specifically designed to coordinate incentivized Risk-Aware Agents (RAAs) for the continuous management of risk and return associated with tokenized assets, wherein said agents autonomously manage operations translating into measurable on-chain financial metrics.

### BACKGROUND OF THE INVENTION

Traditional asset management, particularly for complex ventures or real-world assets, suffers from numerous limitations including manual processes, opacity, latency, and significant intermediary costs. Risk management often relies on periodic human analysis, lacking the continuous adaptability required for volatile markets or dynamic operational environments. Fractional ownership remains cumbersome, hindering liquidity and investor access.

Furthermore, specific industries like hospitality (e.g., restaurants) face high entry barriers due to substantial capital requirements for tangible assets (property, equipment), complex deployment processes (site selection, leasing, staffing), and challenging financing environments. Traditional funding routes like bank loans often have stringent requirements, while equity investment may involve loss of control. Existing ownership models (partnerships, LLCs) can lack transparency and efficient mechanisms for profit distribution, especially dynamic adjustments based on real-time performance.

While blockchain technology offers potential through tokenization and smart contracts, existing applications remain insufficient for realizing true autonomous asset management focused on continuous risk/return optimization. Many (representing prior art in basic tokenization) provide only static representations of ownership or basic transfer functionalities. They fail to address the core challenges of integrating dynamic valuation, real-world operational management, and achieving genuine asset liquidity beyond simple trading. Crucially, they lack protocols specifically architected to enable, coordinate, and manage a system of autonomous AI agents tasked with this continuous management. Prior art often focuses on using blockchain to automate or make verifiable processes related to time/value of money/assets. They do not address the challenge of a protocol actively managing the operational execution strategy of autonomous agents based on dynamic risk/return goals.

Existing approaches combining AI and blockchain typically utilize AI/ML primarily for off-chain analysis, prediction, or triggering predefined on-chain actions. They generally do not disclose protocols featuring specific on-chain incentive structures designed to directly motivate sophisticated Risk-Aware Agent (RAA) actions—including planning, coordination, and execution of operational tasks—based on achieving dynamic risk/return objectives defined by the protocol itself. Mechanisms for protocol-governed, RAA-driven autonomous custody, the integral use of protocol-native stablecoins by RAAs for operational transactions and incentive settlement, verifiable coordination of RAAs for planning and executing tasks impacting asset value, the maintenance of verifiable on-chain RAA performance metrics, and on-chain management of the agent lifecycle are largely absent.

Similarly, protocols developed for Decentralized Autonomous Organizations (DAOs) or basic multi-agent system (MAS) coordination on blockchain may automate simple tasks or facilitate agent discovery/communication, but typically focus on governance voting or basic bot execution. They lack the framework for the blockchain protocol itself to actively manage the ongoing operational strategy and execution quality of specialized Risk-Aware Agents (RAAs) using dynamic, performance-based, on-chain financial incentives directly tied to risk and return. The vital feedback loop—whereby the protocol enables RAAs through risk/return incentives, RAAs plan and execute operations, verifiable performance metrics are recorded on-chain, this performance data feeds back influencing AI analysis, and that analysis refines protocol strategy and on-chain RAA incentives controlling how agents operate—is not realized.

Existing off-chain AI management systems may perform complex analysis or planning but lack the crucial blockchain protocol layer for verifiable coordination, trustless incentive alignment between the protocol and its autonomous Risk-Aware Agents (RAAs) regarding operational performance impacting risk/return, immutable recording of RAA operational and financial performance metrics against specific incentives, and autonomous financial settlement tied directly to the risk/return optimization process achieved through agent actions. Crucially, they lack a framework to verifiably underwrite the operational risks associated with complex ventures using autonomous execution. They cannot provide a unified system where Risk-Aware Agents (RAAs) autonomously manage operations and assets specifically to optimize a risk/return profile defined, enforced, and effectively underwritten by the blockchain protocol itself, thereby failing to establish the trusted operational foundation needed to unlock verifiable value and liquidity potential from traditionally opaque and illiquid assets.

Therefore, there is a significant need for a novel blockchain-based protocol designed not merely to automate time/money events, but to create and manage an ecosystem where the protocol itself directs the operational behavior of autonomous Risk-Aware Agents (RAAs) toward continuous risk/return optimization, thereby enabling the underwriting of operational performance through verifiable autonomous management. This operational underwriting is fundamental to establishing the collateral integrity required to unlock liquidity and enable leverage against these assets. This protocol must provide the framework for: tokenizing assets; assigning specialized Risk-Aware Agents (RAAs) capable of planning, coordinating, and executing complex operational tasks and managing their associated financial representations on-chain; defining verifiable on-chain incentive structures directly linked to risk/return metrics that govern how agents operate; facilitating coordination between AI engines (co-pilots) and operational RAAs via smart contracts; managing the RAA lifecycle and associated operational/financial performance metrics on-chain; enabling protocol-governed, RAA-driven custody for operational purposes; utilizing protocol-native tokens (including a stablecoin whose issuance for leverage relies on the value accrued and stabilized through underwritten operations); embedding compliance; automating financial events reflecting the outcomes of the RAA-driven operations and their translation into financial metrics; and maintaining an immutable record of the entire protocol-agent interaction loop. This system aims to provide verifiable, protocol-underwritten autonomous operational management focused on risk/return, thereby unlocking dead capital and enhancing efficiency.

### SUMMARY OF THE INVENTION

Embodiments provide systems and methods for a comprehensive, AI-driven blockchain protocol architected to enable, coordinate, incentivize, and manage the on-chain lifecycle and performance metrics of autonomous Risk-Aware Agents (RAAs) capable of planning, coordinating, and executing operational tasks for the continuous management of risk and return associated with tokenized assets, effectively underwriting the operational performance through its autonomous control system. This verifiable operational management provides the foundation for unlocking the dead capital associated with such assets, enabling leverage through mechanisms like protocol-native stablecoin issuance against the reliably managed underlying value. Distinctly from prior art focused on automating time-based events or simple financial transactions, this protocol focuses on the continuous management of risk and return by actively directing the operational execution of assigned RAAs through verifiable on-chain incentives. The protocol utilizes AI engines for analysis (potentially setting underwriting criteria via recommended incentives/targets) and relies on RAAs—whose lifecycle, operational/financial metrics, and incentives are managed on-chain via an Agent Coordination Contract/Module—motivated by these incentives, to autonomously perform operations impacting risk/return and update associated on-chain financial state representations (proxies for balance sheet/cash flow items). Agent actions are driven primarily by the protocol's incentive structure, mediating a continuous feedback loop where validated, on-chain RAA performance metrics influence AI analysis, which refines protocol-managed incentives that enforce the underwriting parameters, all recorded immutably while enforcing compliance.

In one aspect, a method involves: receiving configuration data including RAA incentive rules linked to risk/return operational performance metrics; deploying contracts including the Agent Coordination Contract configured to store and update RAA lifecycle status and performance metrics; assigning RAAs and initiating their lifecycle; ingesting data; analyzing data and evaluating RAA operational performance against incentives using stored metrics; transmitting instructions/results; validating (incl. RAA status/metrics check); initiating autonomous actions based on validated inputs; exercising RAA custody; calculating entitlements based partly on validated RAA performance metrics; and automatically transferring stablecoins for settlements and RAA rewards/penalties based on validated performance metrics, potentially updating RAA lifecycle status and metrics on the Agent Coordination Contract.

The protocol enables verifiable autonomous management where Risk-Aware Agents (RAAs), coordinated by the Agent Coordination Contract and motivated by on-chain incentives, execute operational tasks aimed at optimizing risk/return and managing associated on-chain financial representations. RAA performance feeds back into AI engine analysis, informing adjustments to RAA incentive parameters and metrics targets managed on-chain, creating the vital risk/return optimization feedback loop. Protocol-RAA operational interactions, lifecycle events, and metric updates are immutably recorded.

In another aspect, a system comprises: a blockchain; smart contract modules including the core Agent Coordination Module (managing RAA lifecycle, metrics, incentives, validation); a processor; an AI engine; assigned, incentivized Risk-Aware Agents (RAAs) configured for scoped operational planning, execution, management of related financial metrics, and reporting against protocol incentives; wherein components interact under protocol governance for risk/return management, including on-chain management of RAAs, their operations, and their impact on financial metrics, utilizing the stablecoin for incentive settlement, enforcing compliance, and recording activities.

Specific mechanisms highlighting the solution include: protocol-native tokens; a stablecoin used by RAAs for internal settlements and enabling leverage against the operationally underwritten asset value; RAA-driven custody under protocol authorization; verifiable RAA operational execution driven by on-chain incentives tied to on-chain metrics; blockchain recording of RAA lifecycle and performance; a protocol-mediated feedback loop utilizing RAA metrics; event-triggered settlement reflecting outcomes of RAA management; and on-chain management of RAA lifecycle and performance metrics.

By architecting the protocol to manage autonomous Risk-Aware Agent (RAA) operations via on-chain risk/return incentives, verifiable performance metrics, and lifecycle control, enabling these agents to link operational execution to on-chain financial state representations and enabling the underwriting of operational risk through verifiable autonomous execution, the invention provides advantages in verifiable autonomous operational optimization, dynamic value representation, unlocking liquidity via stablecoin leverage founded on reliable RAA-managed operations, efficiency, transparency, security, performance-based control enabling underwriting, and enabling novel investment/management models.

### BRIEF DESCRIPTION OF THE DRAWINGS

FIG. 1 is a block diagram illustrating an exemplary system architecture implementing the protocol, emphasizing the interactions enabling protocol-managed autonomous Risk-Aware Agent (RAA) operations, including the Agent Coordination Contract (104e) managing RAA lifecycle, incentives, and storing/updating on-chain performance metrics within the suite of interconnected smart contracts (104); the figure also depicts off-chain components including the Protocol Management Processor (106), AI Engine (134), assigned RAAs (150), and their interaction with External Data Sources/Operational Environments (146).

FIG. 2 is a flowchart illustrating the core method steps for initiating the protocol and managing RAA registration/lifecycle and metric initialization within its framework, showing the continuous operational loop where RAA performance metrics are evaluated and updated, aligning with the primary independent method claim.

FIG. 3 is a flowchart detailing a specific example of RAA operational reporting, protocol validation against on-chain incentives using performance metrics, and consequent reward/penalty/status and metric updates, illustrating the protocol's enforcement mechanism for RAA operations.

FIG. 4 is a swimlane flowchart illustrating the Holistic AI-driven Risk/Return Management Cycle, visually separating roles (AI Engine analysis, Protocol coordination, RAA operational execution) and showing the continuous feedback loop where protocol-managed incentives and metric targets guide RAA operations, RAA performance metrics feed back into AI analysis, and analysis informs incentive/task/metric target adjustments.

### DETAILED DESCRIPTION OF THE INVENTION

### I. Introduction

The present invention discloses a blockchain protocol, and associated systems and methods, specifically architected to enable, coordinate, incentivize, and manage the lifecycle of autonomous operational Risk-Aware Agents (RAAs) dedicated to the continuous optimization of risk and return for tokenized assets. The protocol distinguishes itself from the prior art, often limited to automating time or basic financial events, by establishing a framework where AI engines provide strategic analysis to set operational risk/return parameters, but day-to-day operational execution is driven by assigned RAAs explicitly motivated by verifiable, on-chain incentives tied to risk/return outcomes, with performance tracked by on-chain metrics, all managed by the protocol itself, allowing the protocol to effectively underwrite the operational execution within defined boundaries. This synergistic integration utilizes interconnected smart contracts deployed on a suitable blockchain network, utilizes protocol-native token structures including a stablecoin functioning as the operational currency for RAAs and as a mechanism for providing leverage against the managed assets, enables RAA-driven autonomous custody within protocol-defined boundaries, embeds compliance logic, and automates the full financial and operational lifecycle based on verifiable RAA operational performance metrics. This provides not only dynamic optimization and transparency but also a crucial solution to the illiquidity or “dead capital” problem typical of such investments, by establishing a trustworthy operational foundation managed by RAAs that supports leverage.

### II. Core Concepts and Definitions

Protocol: Rules, interfaces, and smart contracts defining the operational environment for autonomous Risk-Aware Agents (RAAs), including on-chain lifecycle status management, scope, risk/return-linked incentives, performance metric definitions and validation processes, coordination, and reward/penalty distribution. These rules collectively define the parameters under which the protocol underwrites the autonomous operational performance of its RAAs.

AI Engine: Analytical component assessing risk/return, evaluating RAA operational effectiveness based on reported metrics, and generating instructions primarily to adjust protocol parameters or refine RAA tasks, performance metric targets, and incentive structures via the protocol interface. Its analytical capabilities typically derive from machine learning models developed using standard training and evaluation methodologies. Acts potentially as a strategic co-pilot.

Risk-Aware Agent (RAA): Refers to an autonomous or semi-autonomous software entity whose operational capabilities are typically developed through machine learning training and validated through evaluation. Each RAA is registered with and managed by the protocol via the Agent Coordination Contract/Module (104e). Operates within protocol-defined scope and on-chain lifecycle status, motivated by explicit on-chain risk/return incentives. Internally, may comprise sophisticated AI architectures including perception modules, memory, internal world models (representing operational dynamics and their linkage to key financial indicators like inventory, supply chain, demand, pricing, human factors, and economic indicators), and adaptive reasoning capabilities (planning algorithms, chain-of-thought) for determining action sequences by reasoning over world models to optimize performance against protocol incentives. Configured to perform assigned operational tasks (operating in inference mode) including planning, coordination, execution, and potentially managing specific financial processes by updating designated on-chain metrics representing balance sheet or cash flow elements within its scope. Analyze local risk/return impact using internal models, and report results including relevant operational and financial performance metrics. Its actions are steered by the protocol's incentives designed to optimize operational execution and associated financial outcomes according to a defined risk profile, potentially enabling adaptation based on rewards/penalties.

Tokenized Asset (Native Asset Token): Protocol-specific digital representation managed via the Tokenization Module (104a). Value influenced by operational actions of assigned RAAs. Governed by embedded protocol rules.

Custody (RAA-Driven Autonomous): Protocol-delegated control over assets held within the Custody Management Module (104b). Exercised by RAAs via validated authorizations mediated by the Agent Coordination Module (104e), respecting on-chain RAA lifecycle status and operational limits.

Protocol-Native Stablecoin: Protocol-managed stablecoin issued by the Stablecoin Issuance Module (104d). Stability relies critically on the perceived and actual value of Native Asset Tokens used as collateral. The protocol's active management and underwriting of operational performance underlying these assets (via AI/RAA coordination, tracked by on-chain metrics) aims to stabilize and enhance collateral value. The assessed risk profile associated with the specific RAAs managing the underlying assets may influence stablecoin issuance parameters, linking leverage directly to the quality of operational underwriting. Serves as primary transactional currency for internal operations, distributing financial outcomes (yield/interest via Settlement Module 104c), and settling performance-based rewards/penalties for RAAs via Agent Coordination Module (104e) based on validated metrics.

Agent Coordination Contract/Module (104e): The central on-chain hub managing the protocol-RAA relationship: registration, lifecycle status, scope, enforceable risk/return incentives, storage/update of key operational/financial performance metrics associated with each RAA's activity, report validation against rules/metrics, reward/penalty distribution (stablecoin), and mediation of authorized RAA interactions. Acts as the core enforcement mechanism for the protocol's operational underwriting.

Incentive Structures/Rules: Explicit, on-chain rules within the Agent Coordination Module (104e) defining operational performance metrics (tracked on-chain) and corresponding stablecoin rewards/penalties for associated RAAs. The protocol's primary mechanism for directing autonomous RAA operational behavior towards desired risk/return outcomes that meet the protocol's underwriting standards.

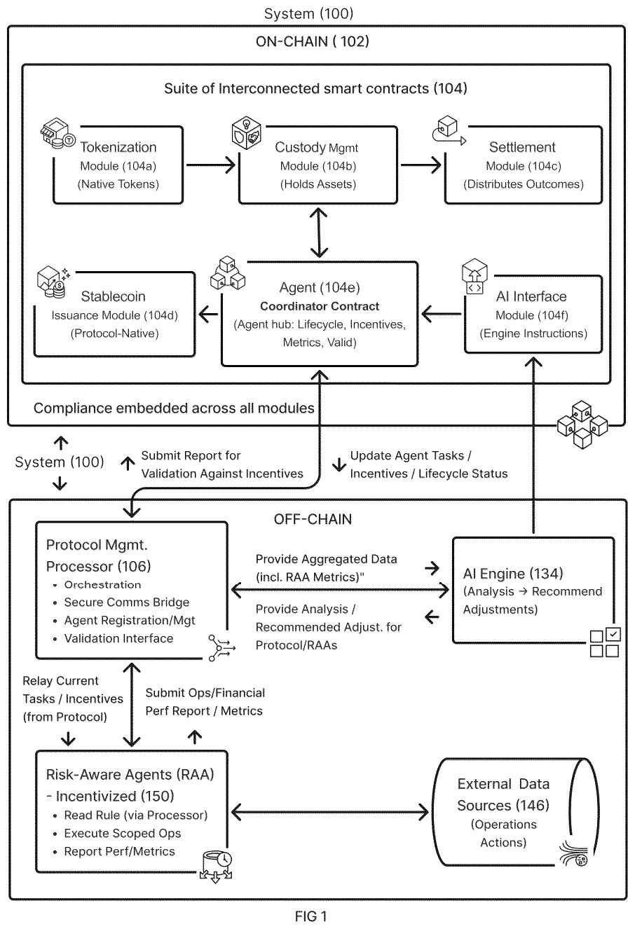

### III. System Architecture (ref FIG. 1)

An exemplary System (100), illustrated conceptually in FIG. 1, comprises On-Chain (102) and Off-Chain components. The On-Chain environment on the Blockchain Network (102) hosts the Suite of Interconnected Smart Contracts (104). This suite includes a Tokenization Module (104a) managing Native Tokens, a Custody Management Module (104b) holding assets and executing authorized transactions, a Settlement Module (104c) distributing financial outcomes, a Stablecoin Issuance Module (104d) managing the protocol-native stablecoin, the central Agent Coordination Contract/Module (104e) managing RAA lifecycle, scope, incentives, metrics, and validation, and an AI Interface Module (104f) receiving instructions from the off-chain AI Engine (134). Compliance logic is embedded across these modules (104). Interactions with the Off-Chain environment are mediated by the Protocol Management Processor (106). The Processor manages configuration, orchestrates communication, registers/manages RAAs and their metric initializations via the Agent Coordination Module (104e), validates RAA reports containing metric data before submitting them to the Agent Coordination Module (104e), and relays current tasks/incentives/targets from the protocol to the RAAs (150). The AI Engine (134) performs holistic analysis based on aggregated data including on-chain RAA metrics, generating recommendations potentially including adjustments to RAA incentives or performance metric targets. The Assigned, Incentivized Risk-Aware Agents (RAAs) (150) operate off-chain, reading tasks/incentives/targets from the Agent Coordination Module (104e) via the Processor (106), executing scoped operational actions potentially interacting with External Data Sources/Operational Environments (146), analyzing their impact, and reporting performance including metrics back to the Processor (106). This architecture facilitates the protocol's active management of RAA operations and measurable performance for risk/return optimization, with activities immutably recorded.

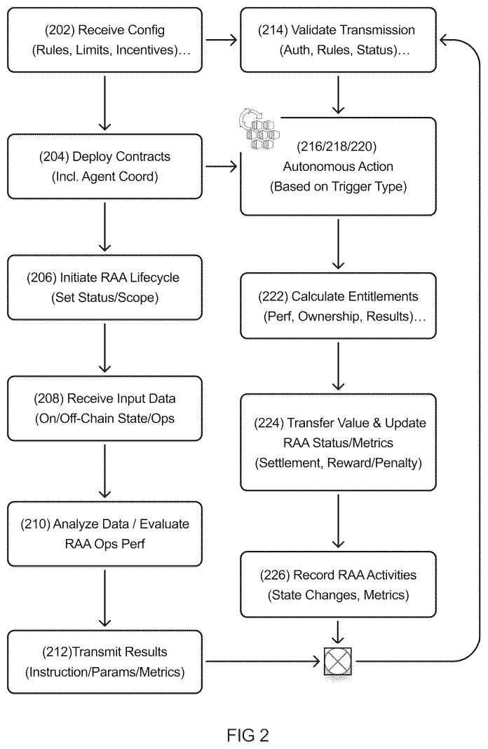

### IV. Core Protocol Method (ref FIG. 2)

The core method, illustrated conceptually in FIG. 2 aligning with Claim 1, establishes the protocol framework including agent metric management. (202) Receive Configuration includes rules, operational limits, RAA scope, lifecycle, performance metrics definitions, and risk/return incentives. (204) Deploy/Configure Smart Contracts includes the Agent Coordination Contract (104e) with logic for lifecycle, metrics, and incentives. (206) Initiate RAA Lifecycle & Metrics sets initial status, scope, and initializes performance metrics in the Agent Coordination Contract (104e). (208) Receive Input Data includes current on-chain RAA metrics. (210) Analyze Data & Evaluate RAA Performance evaluates RAA operational performance against incentives using stored metrics. (212) Transmit Instructions/Parameters/Performance Results include relevant metric data. (214) Validate Transmission checks authenticity, rules, RAA status, and potentially metric thresholds via the relevant smart contract module (often 104e). (216/218/220) Initiate Autonomous Action based on the validated trigger. (222) Calculate Entitlements informed by validated RAA performance metrics. (224) Transfer Value executes settlements/RAA rewards/penalties based on validated metrics, and updates RAA status and associated metrics on the Agent Coordination Contract (104e). (226) Record Activities include RAA status updates and incentive payouts. The loop returns to (208).

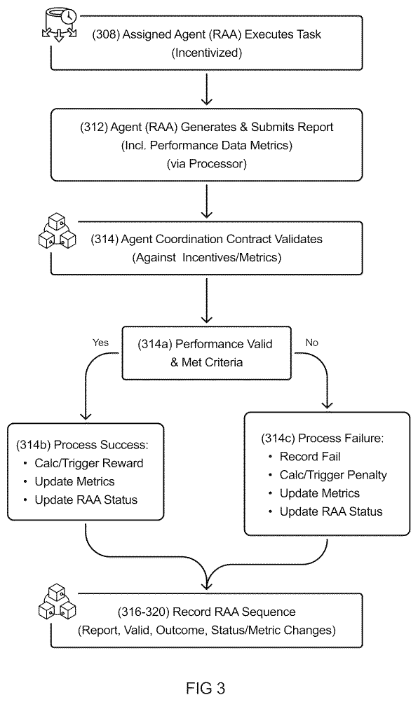

### V. Blockchain Recording and Agent Lifecycle/Incentive Example (ref FIG. 3)

FIG. 3 provides a granular example incorporating on-chain RAA metrics. (308) An Assigned RAA Executes an Operational Task, driven by on-chain incentives and aiming for metric targets defined in the Agent Coordination Contract (104e). (312) The RAA Submits a Report including performance data corresponding to defined metrics. (314) The Agent Coordination Contract (104e) validates this report against incentive rules and compares reported data to metric targets/thresholds. If successful (314b), the contract (104e) calculates/triggers a stablecoin reward based on metric achievement, updates relevant RAA performance metrics on-chain positively, and may update status. If unsuccessful (314c), it processes failure, potentially triggers a stablecoin penalty, updates metrics negatively or as failure, and may update lifecycle status negatively. (316-320) The entire sequence—RAA action report, validation result, reward/penalty, resulting RAA status, and metric changes—is recorded immutably.

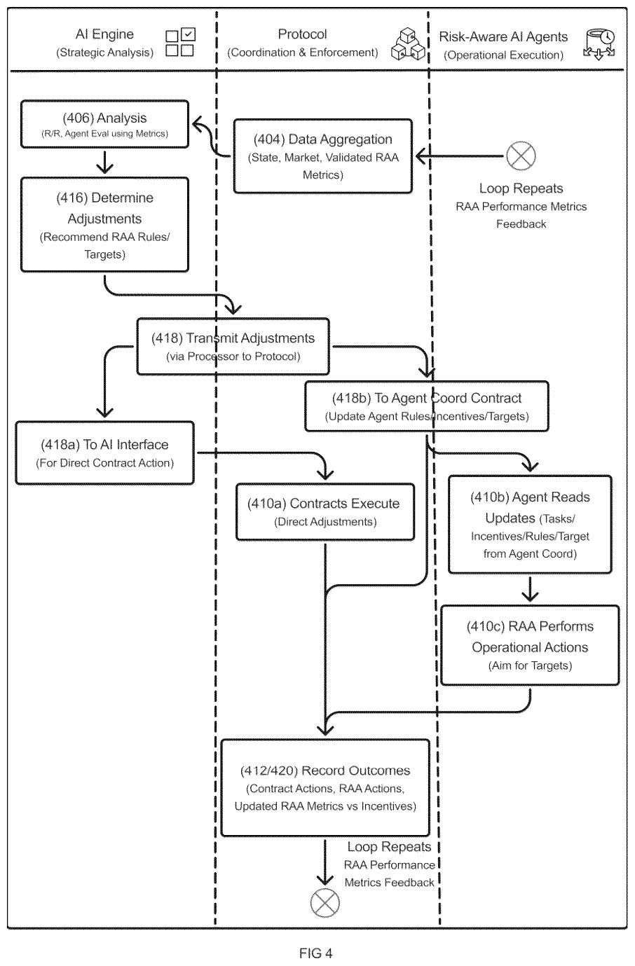

### VI. Holistic AI-Driven Risk/Return Management Cycle (ref FIG. 4)

FIG. 4 (swimlane view) details the continuous optimization cycle incorporating metrics. Protocol lane: (404) Aggregates data including validated RAA operational/financial metrics and validated reports. AI Engine lane: (406) Analyzes data, and evaluates RAA performance using current metrics against incentives. (416) Determines adjustments, potentially recommending changes to RAA tasks, incentives, scope, lifecycle rules, or metric targets managed by the protocol. Protocol lane: (418) Receives adjustments. Instructions may trigger (410a) Direct Contract Actions or (418b) update the Agent Coordination Contract (104e) with new RAA directives including metric targets. Risk-Aware Agents (RAAs) lane: (410b) RAAs read updated directives including targets from the Agent Coordination Contract (104e). (410c) RAAs perform operational actions aiming for metric targets. Performance (including metrics) is reported back. Protocol lane: (412/420) Records outcomes including updated RAA performance metrics. This Performance Metrics Feedback closes the loop to (404), enabling the protocol to continuously refine RAA operational strategy via on-chain incentives based on AI analysis.

### VII. Specific Implementations and Features

Protocol-Native Tokens and Stablecoin: The protocol manages Native Asset Tokens via the Tokenization Module (104a). The Protocol-Native Stablecoin issued by the Stablecoin Issuance Module (104d) acts as the intra-protocol currency facilitating RAA operations and settling performance-based incentives via the Agent Coordination Module (104e) or Settlement Module (104c). Stability mechanisms might involve dynamic adjustment of collateralization ratios or fees, based on the operational outcomes reported by the autonomous RAAs (including their performance metrics) and the analysis performed by the AI engine (134).

Embedded Compliance: Involves implementing logic within the Tokenization (104a) and Agent Coordination (104e) modules. Examples include checks against on-chain registries, enforcing jurisdictional restrictions, or implementing compliance logic mapped from relevant financial regulations, such as those promulgated by the SEC or other authorities, to govern specific token functionalities and potentially certain types of RAA-initiated actions within the protocol's ruleset.

Autonomous Asset/Strategy Adjustments: Direct adjustments by contracts (triggered by AI Engine (134) via AI Interface Module 104f) complement adjusting RAA operational behavior via incentives managed by the Agent Coordination Module (104e). This could involve interacting with integrated DeFi protocols or modifying operational contract parameters.

Risk-Aware Agent (RAA) Autonomous Custody: Protocol delegates custody authority to RAAs. Agent Coordination Module (104e) acts as a gatekeeper for the Custody Module (104b), granting permissions based on RAA on-chain status, scope, and potentially metrics. Allowed actions might include RAAs utilizing tokens for operational needs like acquiring inputs, transferring value according to validated results, depositing assets into protocol-managed vaults, providing tokens as collateral for protocol-native stablecoin issuance where authorized, or participating in protocol-internal lending mechanisms for yield generation. Authorization may require multi-factor authorization (MFA) or multi-party computation (MPC) schemes potentially involving cryptographic checks by the protocol itself or requiring consensus from other designated RAAs managing the specific asset for critical operations.

Risk-Aware Agent (RAA) Operational Planning & Execution: Internally, RAAs (150) may employ various AI techniques, including reinforcement learning, planning algorithms, or expert systems, to determine optimal actions based on their assigned tasks and current incentive structure retrieved from the protocol. Each unique RAA utilizes its own cryptographic signature authority, such as a securely managed private key, to authenticate its communications and reported results submitted to the protocol via the processor (106). Validation by the Agent Coordination Module (104e) relies on verifying these digital signatures alongside evaluating the submitted performance data against incentive rules and stored metrics. An RAA's scope could explicitly include managing certain financial contracts represented as smart contracts or tracked states within the protocol; for example, autonomously triggering pre-approved supplier payments upon validated goods receipt (impacting COGS metrics), requesting stablecoin drawdowns from a protocol vault based on demonstrating positive working capital metrics according to its world model, or executing actions designed to optimize an on-chain representation of a simplified operational balance sheet (e.g., minimizing waste metrics, maximizing asset utilization metrics).

Blockchain Recording of Agent Lifecycle and Metrics: Agent Coordination Module (104e) maintains state variables for RAA status (Pending, Active, Suspended_Penalty, Suspended_Manual, Terminated states). It also maintains key operational and financial performance metrics associated with each RAA's activity, updated based on validated reports. These on-chain metrics form a core part of the RAA's managed state, influence incentive calculations, and serve as input for AI Engine (134) analysis.

Holistic Management Cycle: Data aggregation involves integrating on-chain data, oracle feeds, on-chain RAA metrics (from 104e), and relevant offline operational data derived from RAA (150) activities potentially involving external sources (146). The AI engine (134) uses this comprehensive dataset for modeling, simulation, and optimization of overall strategy and RAA directives, including performance metric targets updated via the Agent Coordination Module (104e).

Automated Distribution & Settlement: Implementation may involve protocol-native endpoints managing interactions with tokens/vaults. Trigger events initiate processes within the Settlement Module (104c) reflecting outcomes of AI-managed, RAA-driven operational performance. Off-chain event validation relies on verifiable digital signatures or potentially multiple independent oracle sources before settlement actions are executed.

### VIII. Enablement Details

Implementation of the described systems and methods requires the integration of expertise and potentially specialized components across blockchain engineering, artificial intelligence, secure systems design, and potentially specific domain knowledge related to the assets being managed. While standard tools form a basis, realizing the invention necessitates addressing specific technical challenges beyond generic implementation, sufficient to teach a Person Having Ordinary Skill In The Art (PHOSITA) how to make and use the invention without undue experimentation. These challenges and enablement considerations include the following:

Sophisticated Smart Contract Logic (Agent Coordination): The Agent Coordination Module (104e) demands non-trivial smart contract development beyond typical token contracts. Its logic must handle complex state management for potentially numerous RAAs, including implementing on-chain lifecycle state machines (managing transitions between states like Active, Suspended based on performance), defining and utilizing secure storage/update mechanisms (e.g., mappings, structs, arrays) for diverse operational and financial performance metrics associated with each RAA, implementing potentially complex, multi-factor incentive calculation logic based on validated metrics against configurable rules (curves, thresholds), implementing robust validation logic for agent reports (potentially checking data consistency, sequence, or cryptographic proofs), and implementing secure mediation logic for authorization requests to other modules (like Custody Module 104b) based on RAA status, scope, and metrics. This requires expertise in advanced Solidity or similar smart contract language development and gas optimization techniques.

Secure and Verifiable Protocol-Agent Communication: Establishing secure, reliable, and verifiable communication channels between potentially numerous off-chain RAAs (150) and the on-chain Agent Coordination Module (104e), typically via the Processor (106), is critical. This involves not only standard secure transport (e.g., TLS, authenticated APIs) but potentially mechanisms for ensuring the integrity and authenticity of RAA-reported operational data and performance metrics submitted for on-chain validation. Solutions may involve RAAs cryptographically signing reports using unique, securely managed keys (potentially via hardware security modules or secure enclaves), potentially incorporating zero-knowledge proofs (e.g., zk-SNARKs) or other verifiable computation techniques for complex off-chain actions where direct verification is infeasible, or utilizing consensus mechanisms among specific RAA groups for critical data reporting, ensuring the data used for on-chain incentive calculation is trustworthy. The Processor (106) must be configured to handle these verification steps before relaying data on-chain.

AI Model Development and Integration: Developing functional AI Engines (134) and RAAs (150) requires standard AI/ML practices but tailored to the protocol's specific needs. The AI Engine needs models (e.g., predictive, optimization, simulation models) capable of analyzing the specific on-chain RAA metrics and protocol state provided via the Processor (106) to generate meaningful recommendations for adjusting on-chain incentive parameters or metric targets within the Agent Coordination Module (104e). RAAs (150) require internal models (e.g., world models representing operational dynamics, potentially using techniques like reinforcement learning, planning algorithms, Bayesian networks, or expert systems) specifically designed to perceive their environment (via data inputs), reason about actions, and optimize behavior based on the dynamic, on-chain incentive structures provided by the protocol (retrieved via Processor 106). This necessitates co-design of AI agent capabilities and protocol incentive mechanisms, along with expertise in training, evaluation, deployment (inference), and potentially continuous refinement (MLOps) of these models within the integrated system.

Processor Orchestration and Security: The Protocol Management Processor (106) requires robust software architecture (e.g., microservices, event-driven) for orchestration, managing asynchronous communication, potentially handle large volumes of agent reports, performing initial validation/formatting, securely managing credentials for blockchain interaction, and reliably transmitting authenticated instructions/data between the AI Engine (134), RAAs (150), and on-chain modules (104). High availability, fault tolerance, and security against external attacks are critical design considerations.

On-Chain Data Management: Efficiently storing and updating potentially granular RAA status and performance metric data within the Agent Coordination Module (104e) requires careful smart contract design considering blockchain state size limitations and transaction costs (gas). Optimized data structures (e.g., packed structs, efficient mapping patterns) and judicious use of event emission for indexing and enabling off-chain monitoring (via Processor 106 or external indexers) are necessary implementation details.

Incentive Mechanism Design: Crafting the specific on-chain incentive rules within the Agent Coordination Module (104e)—defining metrics, targets, reward curves, penalty functions—requires careful economic modeling and potentially game-theoretic analysis to ensure they effectively align sophisticated RAA behavior with desired risk/return objectives without creating unintended consequences or exploitable loopholes. This design process is a key aspect of configuring the protocol via the configuration data received by the Processor (106).

Integration with External Systems: Enabling RAAs (150) to interact effectively with external data sources or operational environments (146) requires developing or utilizing secure and reliable interfaces (e.g., standardized APIs, IoT protocols, data adapters). Ensuring the integrity of data received from, and the security of commands sent to, these external systems is part of the overall system enablement.

Addressing these specific technical requirements, involving the described components (102, 104a-f, 106, 134, 150, 146) and their interactions as illustrated in FIGS. 1-4, enables a PHOSITA to make and use the claimed invention without undue experimentation, demonstrating that the invention comprises concrete technical solutions beyond abstract ideas or generic computer implementations.

### IX. Novelty and Non-Obviousness

The invention's novelty and non-obviousness arise primarily from the protocol's specific architecture and integrated mechanisms designed to actively manage autonomous Risk-Aware Agent (RAA) operations via on-chain rules for continuous risk/return optimization, specifically enabling the protocol to underwrite operational performance and leverage this underwriting to solve asset illiquidity, distinguishing it significantly from prior art:
a. Shift from Time/Money Automation to Protocol-Managed Risk-Aware Agent Operations: Protocol manages the ‘how’ and ‘how well’ of complex RAA operational behavior via dynamic incentives.
b. Protocol-Centric RAA Coordination, Risk/Return Incentivization, Metric Tracking, & Lifecycle Management: Agent Coordination Module (104e) as an on-chain hub managing RAA scope, lifecycle status, verifiable risk/return incentives, operational/financial performance metrics, validation, and reward/penalty distribution.
c. Synergistic AI Engine (Co-Pilot) & Incentivized RAA Operational Loop for Underwriting: Protocol-mediated continuous feedback loop where analysis influences on-chain RAA incentives/tasks and performance metric targets managed by Agent Coordination Module (104e).
d. Integrated Protocol-Native Stablecoin Specifically for RAA Operational Incentive Settlement Based on Metrics.
e. Protocol-Delegated RAA-Driven Autonomous Custody (Lifecycle/Metric-Aware): Custody control under protocol rules considering RAA on-chain lifecycle status and potentially metrics stored in Agent Coordination Module (104e).
f. Full Lifecycle Autonomous Operational & Financial Management Enabling Underwritten Leverage: Integrated system where the protocol directs/verifies operational performance of its lifecycle-managed RAAs via on-chain incentives and metrics, using this verified operational stability as the basis for enabling stablecoin-based leverage.

### X. Broader Applicability

While exemplified by complex ventures, the protocol's core functionalities - enabling AI analysis to guide protocol-coordinated, incentivized, lifecycle-managed autonomous Risk-Aware Agent (RAA) execution for operational management informed by on-chain metrics, risk/return optimization, RAA-managed custody, automated financial operations, and the verifiable underwriting of complex autonomous processes - offer a powerful framework applicable to diverse tokenized assets requiring dynamic, verifiable autonomous management.

What is claimed is:

1. A method for autonomously managing tokenized assets representing an operational venture via a blockchain protocol, the method comprising:
a. deploying, by at least one processor, an agent coordination contract on a blockchain network, said agent coordination contract configured to store on-chain incentive rules and manage on-chain lifecycle status and performance metrics for a plurality of autonomous operational agents;
b. assigning, via said agent coordination contract, at least one of said plurality of autonomous operational agents to the operational venture;
c. receiving, at said agent coordination contract, a performance report from said at least one agent, said report containing operational data resulting from an action performed by said at least one agent;
d. autonomously processing, by said agent coordination contract, said performance report against said on-chain incentive rules to determine a performance outcome; and
e. autonomously modifying, by said agent coordination contract and/or a settlement contract responsive thereto, at least one of: (i) said at least one agent's on-chain lifecycle status, (ii) said at least one agent's on-chain performance metrics, and (iii) a state of said tokenized assets based on said determined performance outcome.

2. The method of claim 1, wherein said performance outcome comprises a reward and/or a penalty, and wherein said autonomously modifying comprises automatically triggering, by said agent coordination contract, a transfer of a protocol-native stablecoin corresponding to said reward and/or penalty.

3. The method of claim 1, wherein said on-chain lifecycle status is selected from a plurality of predefined lifecycle statuses comprising at least an ‘Active’ state, a ‘Suspended’ state, and a ‘Terminated’ state.

4. The method of claim 3, further comprising preventing said at least one agent from executing a transaction via a custody contract when its on-chain lifecycle status is ‘Suspended’ and/or ‘Terminated’.

5. The method of claim 1, further comprising:
analyzing, by an AI engine, a history of said on-chain performance metrics to generate a projection of future operational cash flow for the operational venture; and
determining a maximum allowable leverage amount for said tokenized assets as a function of said projection of future operational cash flow.

6. The method of claim 5, further comprising enabling the issuance of a quantity of protocol-native stablecoins against said tokenized assets as collateral, wherein said quantity is constrained by said determined maximum allowable leverage amount.

7. The method of claim 5, wherein said function of said projected future operational cash flow comprises applying a discount factor to said projection to determine a net present value, wherein said maximum allowable leverage amount is based on said net present value.

8. The method of claim 1, wherein at least one of said plurality of autonomous operational agents is a specialized Financial Controller Agent (FCA), and wherein the performance report received in step (c) is a cryptographically signed health report from said FCA comprising values for a plurality of on-chain financial performance metrics representing an operational health of the operational venture.

9. The method of claim 8, further comprising:
determining, by an AI engine based on an analysis of said on-chain financial performance metrics from said health report, an updated set of financial product parameters; and
autonomously adjusting, by one or more smart contracts, the terms of at least one financial product related to the operational venture according to said updated parameters.

10. The method of claim 9, wherein said at least one financial product is an incentive mechanism for others of said plurality of autonomous operational agents, and said financial product parameters comprise reward and/or penalty amounts stored in said agent coordination contract.

11. A system for autonomously managing tokenized assets representing an operational venture, the system comprising:
a. a blockchain network;
b. an agent coordination module deployed on said blockchain network, said module comprising a smart contract configured to:
i. store on-chain incentive rules;
ii. maintain a registry for a plurality of autonomous operational agents, said registry managing an on-chain lifecycle status and on-chain performance metrics for each of said agents;
iii. include a function to receive and autonomously process a performance report from at least one of said agents against said on-chain incentive rules to determine a performance outcome; and
iv. include logic to autonomously modify at least one of: said at least one agent's on-chain lifecycle status, said at least one agent's on-chain performance metrics, and/or a state of said tokenized assets based on said determined performance outcome.

12. The system of claim 11, wherein said agent coordination module is further configured to trigger a transfer of a protocol-native stablecoin corresponding to a reward and/or penalty as part of processing said performance outcome.

13. The system of claim 11, further comprising an AI engine communicatively coupled to said agent coordination module, wherein the AI engine is configured to:
retrieve a history of said on-chain performance metrics;
generate a projection of future operational cash flow for the operational venture based on an analysis of the history; and
determine a maximum allowable leverage amount for said tokenized assets as a function of said projection.

14. The system of claim 13, further comprising a stablecoin issuance module configured to enable issuance of a quantity of protocol-native stablecoins against said tokenized assets as collateral, wherein said quantity is constrained by the maximum allowable leverage amount.

15. The system of claim 11, wherein at least one of said plurality of autonomous operational agents is a specialized Financial Controller Agent (FCA) configured to generate said performance report as a cryptographically signed health report representing an operational health of the operational venture.
